(19) United States
(12) Patent Application Publication
(10) Pub. No.: US 2021/0397620 A1
(43) Pub. Date: Dec. 23, 2021

(54) CONFIGURABLE GOVERNMENT PROCESS AUTOMATION ON MULTI TENANT PLATFORM SYSTEMS

(71) Applicant: CLARITI CLOUD INC., Vancouver (CA)

(72) Inventors: James WIKKERINK, Vancouver (CA); Oliver WOOLGAR, Burnaby (CA); Xiali SUN, North Vancouver (CA); Veronica Gustilo DELUNA, Port Coquitlam (CA); Muzill WAHID, Surrey (CA); Amrita PATRA, New Westminster (CA); Gener IGLESIAS, Surrey (CA); Vishal RATHOD, Vancouver (CA); Sara GIVEN, Vancouver (CA); Mostafa ASADI-MOGHADAM, Burnaby (CA); Michael Joseph TOGYI, North Vancouver (CA); Nicole DECLOUX, North Vancouver (CA); Alfredo CANTU MARTINEZ, Vancouver (CA); Jake DANCYGER, Vancouver (CA)

(21) Appl. No.: 17/351,773

(22) Filed: Jun. 18, 2021

Related U.S. Application Data
(60) Provisional application No. 63/041,225, filed on Jun. 19, 2020.

(51) Int. Cl. G06F 16/2455; G06F 9/451; G06F 16/248

(52) U.S. Cl. CPC G06F 16/24565; G06F 16/248; G06F 9/451

(57) ABSTRACT

Systems and methods relating to leveraging a cloud computing platform for use in providing a consumer with applications relating to the provision of government services. Methods for efficiently implementing rule-based database operations using a multi-tenant platform are discussed along with the automatic generation of user interfaces for such applications.

### RELATED APPLICATIONS

This application is a non-provisional patent application which claims the benefit of U.S. Provisional Application No. 63/041,225 filed on Jun. 19, 2020.

### TECHNICAL FIELD

The present invention relates to cloud computing. More specifically, the present invention relates to systems and methods for utilizing cloud computing platforms to provide clients with applications by leveraging the resources of the platforms.

### BACKGROUND

The developments in the high-tech sector in the early part of the 21st century have brought a number of enhancements to how businesses are run. By the second decade of the 21st century, online access to businesses and government services is not just widespread, it is almost necessary.

To ensure that such online access to services is both scalable and easy, one development has been the rise of the online application platform. Nowadays, online cloud computing platforms such as Amazon, Salesforce, and Google are well-known. Entities such as businesses and government agencies can implement their portals and their customer-centric applications on these platforms without the need to manage and/or acquire their own dedicated servers. These platforms provide suitable interfaces and resources to allow for easy scalability for such applications. However, as can be imagined, navigating and implementing applications atop such platforms may not be as easy as it seems.

As is well-known in the field, each platform has its own idiosyncrasies and its own way of implementing common (and sometimes necessary) features. Implementing different portals and different user interfaces can be difficult, especially given how different these platforms are from one another. What is required are methods and systems that, when implemented, can be applicable to at least one of these platforms.

### SUMMARY

The present invention provides systems and methods relating to leveraging a cloud computing platform for use in efficiently providing a consumer with applications relating to the provision of government services. Methods for efficiently implementing rule-based database operations using a multi-tenant platform are discussed along with the automatic generation of user interfaces for such applications.

In a first aspect, the present invention provides a method for managing changes to a database, the method comprising:

(a) receiving input from a consumer requiring at least one change to at least one record in a database;

(b) determining a plurality of candidate rules that would need to be implemented if triggering events for each of said candidate rules have occurred because of said at least one change;

(c) pre-processing said plurality of candidate rules to determine if all triggering events for each of said candidate rules have occurred;

(d) pre-processing all conditions for all candidate rules for which all triggering events have occurred to determine if said all conditions have been met;

(e) pre-processing consequences for all candidate rules for which all triggering events have occurred and for which all conditions have been met;

(f) implementing said consequences for said all candidate rules for which all triggering events have occurred and for which all conditions have been met;

wherein, for each rule,
said rule is only implemented when all of said rule's triggering events have occurred, an implementation of said rule includes determining if said one or more conditions are met and, if said one or more conditions are met, implementing said consequences for said rule.

In a second aspect, the present invention provides a method for managing changes to a database, the method comprising:

(a) receiving a request from a consumer for services, said services requiring at least one change to at least one record in said database;

(b) determining a plurality of candidate rules whose triggering events need to be evaluated to determine if said rules are to be executed for said services, each of said candidate rules being user defined and having one or more triggering events, one or more conditions, and one or more consequences;

(c) determining one or more records affected by an evaluation of said triggering events for each of said candidate rules and retrieving said one or more records;

(d) evaluating said triggering events using said one or more records retrieved in step (c);

(e) discarding candidate rules for whom at least one triggering event has not occurred to result in remaining candidate rules;

(f) for each of said remaining candidate rules, determining one or more records affected by an evaluation of conditions for each of said remaining candidate rules;

(g) retrieving and caching said one or more related records determined in step (f) and evaluating said conditions for said each of said remaining candidate rules;

(h) for each of said remaining candidate rules for which conditions have been met, determining which change records would be affected by an implementation of consequences for each of said remaining candidate rules for which conditions have been met;

i) pooling and committing changes to said change records determined in step (h) in accordance with said consequences for each of said remaining candidate rules for which conditions have been met;

wherein, for each rule,
said rule is only implemented when all of said rule's triggering events have occurred, an implementation of said rule includes determining if said one or more conditions are met and, if said one or more conditions are met, implementing said consequences for said rule.

In a third aspect, the present invention provides a method for dynamically generating a user interface containing user fillable fields, said user interface being related to a specific process, the method comprising:

a) retrieving data detailing required data fields for said user interface and field indicators for said required data fields;

b) retrieving data detailing resources related to said process;

c) retrieving data detailing components to be used for said user interface and procedures for handling said component object types;

d) generating a visual tree representation detailing components to be used for said user interface;

(e) traversing said visual tree representation to determine how each component is to be generated or presented to a user;

(f) rendering said user interface based on results of step (e).

In a fourth aspect, the present invention provides a system for managing consumer initiated requests relating to government services, the system comprising

a dynamic rules engine embodied in computer readable and computer executable instructions, said dynamic rules engine being for implementing and assessing a plurality of rules relating to said requests, said requests relating to records in at least one database;

a dynamic user interface engine embodied in computer readable and computer executable instructions, said dynamic user interface engine being for generating a user interface for use by said consumer to initiate said requests;

wherein said dynamic rules engine receives consumer input by way of said user interface generated by said dynamic user interface engine.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system and environment on which the various aspects of the present invention may be practiced;

FIG. 2 is a block diagram illustrating the various modules and components that may be present in a system according to the various aspects of the present invention;

FIG. 3 is a screenshot of a sample rule definition screen which may be used by users to define rules for use with the present invention.

### DETAILED DESCRIPTION

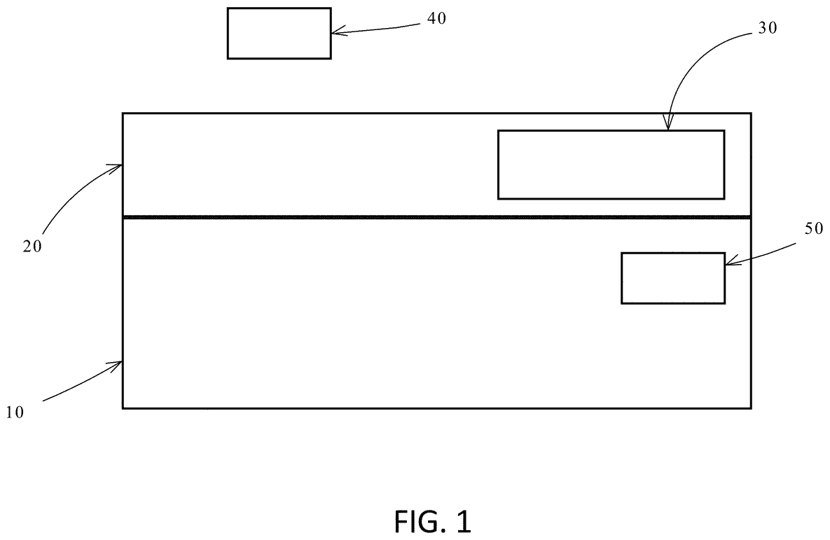

Referring to FIG. 1, a block diagram of an environment on which the present invention may be implemented. As can be seen, there is an existing software or cloud computing platform 10, and a user-facing intermediary system 20 that implements a client application 30. As can be seen, the intermediary system 20 interacts with the various components of the software platform 10 to provide a consumer 40 with services. These services may involve a database 50 that is part of the platform 10. It should be clear that a consumer is an ultimate user of the overall system (i.e. a member of the general public) while a user is an internal system user such as an administrator or IT personnel managing various parts of the system.

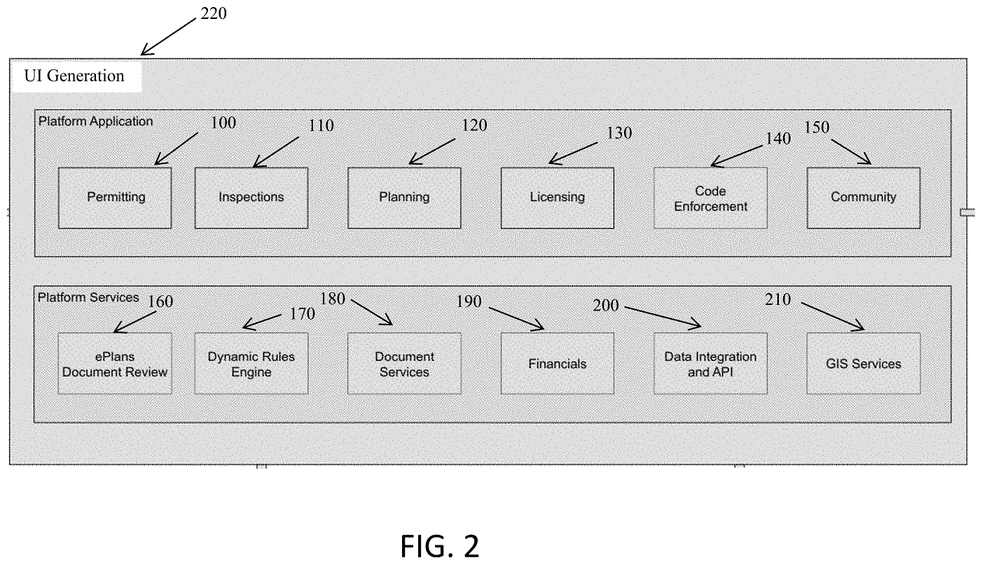

Referring to FIG. 2, a block diagram of the some of the components of the intermediary system 20 are illustrated. As can be seen, a number of specific applications/modules are provided to address a number of services that can be provided to consumers. A permitting module 100 is shown along with an inspections module 110. A planning module 120, a licensing module 130, and a code enforcement module 140 are present along with a community module 150. It should be clear that these modules are examples and other modules are possible. In this implementation of the system, the intermediary system is configured to provide access by consumers to government services. Thus, a consumer can, using the intermediary system, apply for and receive permits, apply for and schedule inspections, apply for and be notified of planning permits or planning related permissions, apply for and receive various types of licenses, notify and be notified about code or regulation enforcement (e.g. pay parking tickets, pay speeding tickets, etc., etc.), and be notified or address community concerns.

In one implementation, the permitting module 100 allows for unlimited permit types (e.g. building permits, MEP, environmental permits, etc.) as well as child/parent permits. The permitting module 100 can also allow for plans submission management so that consumers can submit plans that require authorizations and permits (e.g. building plans, renovation plans, etc.).

The licensing module 130 can be configured to provide a full range of available licenses including professional licenses, licensing of tradespeople, licensing for facilities, liquor licenses, vehicle licenses, animal licenses, and the like. The licensing module 130 can be configured to interact with or be interoperable with other modules such that consumers can attend to their license applications, renewals, fee payments, documentations, and submissions by way of this module.

The inspections module 110 allows consumers to schedule inspections while also allowing inspectors to arrange for their inspection routes. With suitable GIS integration, the module allows inspectors to review/track their itinerary for any given day as they perform their inspections. Additionally, after each inspection, inspectors can, using this module, automatically issue a notice of violation and have that notice dispatched to a consumer.

The code enforcement module 140 allows for the management of ordinance/bylaw enforcement as well as for management of complaints from the public relating to ordinances or bylaws. Inspectors who need to ensure compliance with ordinances and bylaws are able to schedule and manage their itineraries similar to the capability for module 110. This enforcement module 140 can also attend to managing code/regulation/ordinance violations, fines and fine payment management for current and past violations, as well as adjudication for offences. The module can implement an automated conditional re-inspection so that, after every violation or every fine payment, a follow up inspection is automatically scheduled.

To implement the various functions and capabilities of the various modules illustrated, a number of functional modules (which can be embodied in computer readable and computer executable instructions) are provided in the intermediary system. These include: a document review module 160, a dynamic rules engine 170, a document services engine 180, a financial module 190, a data integration module 200, and a GIS services module 210.

As can be imagined, the document review module 160 allows consumers to submit and have reviewed plans that they may need to submit for various licenses or permits. The dynamic rules engine 170 manages the various rules that need to be applied regarding the different consumer requests and/or the records in the database that are affected by consumer requests (e.g. database records dealing with a consumer's driver's license). The document services module 180 deals with documentation that the system generates and ensures that communications with relevant consumers are attended to. As an example, receipts, permits, notifications, and other automatically generated documentation may be sent out by the module 180 to the email addresses (or postal addresses) of the concerned consumers. This document services module also provides custom document and form creation functionality to users and performance is scalable on demand. The financial module 190 attends to consumer payments, their receipt, their processing, the acknowledgement of such payments, and the accounting representation of such activities or transactions. Thus, transactions and/or automatic operational matters dealing with payments and accounts are dealt with by this module. The GIS services module 210 integrates with the other modules that may require mapping services, geotracking services, or other services dealing with mapping and the like. The GIS services module may also provide services relating to spatial analyses and automated workflows driven by spatial data.

Part of the system is a user interface module 220. This module is concerned with the user interface presented to consumers when consumers access the various portals or applications for the various modules.

In one aspect of the present invention, the system operates by providing a Dynamic Rules Engine (DRE) that functions in conjunction with the platform's built-in database. For some implementations, changes to the database are initiated and/or performed on behalf of a consumer. These database changes, including addition, removal, and editing/changing of database records, are performed after a consumer requests such changes. To manage such changes, rules governing the database records are created by users and these rules are managed/executed by the DRE.

Each of the rules managed by the DRE is defined by a specific set of conditions. Each rule may be broken down into its components as follows:

WHEN X

IF Y

THEN Z

action A

This means that, when at least one event X (which may be a combination of events) occurs, then the rest of the rule is to be executed. Thus, assuming the event X occurs, then IF condition Y is true, then consequence Z is performed and then action A (which may be optional) is also performed. These rules may involve database functions such as record additions, deletions, or amendments. It should, of course, be clear that the actions noted above may include multiple related or unrelated actions. Thus, “action A” noted above includes the possibility that there are multiple actions that occur or are performed. It should also be clear that, while event X (which may be one or more events) is a triggering event that causes the execution of the rule or which triggers the implementation of the rule, event X may include a specific call for that specific rule to be implemented, i.e. a call for the rule through, for example, an API. Thus, a user or a subroutine may call a specific rule into implementation or execution if one of the rule's defined triggering events is a specific call for that rule. In some implementations, calling for the rule's execution may return the rule's result to the subroutine/user calling the rule.

It should be clear that, for platforms that are multi-tenant platforms, there are a number of limits (e.g. platform mandated Governor limits) that could severely hamper the workings of any application that requires multiple database/record reads, writes, or retrievals. To this end, since multiple rules need to be evaluated to determine if each or any of the rules need to be executed, the intermediary system can pre-process the various rules. Thus, instead of executing each rule (and wasting valuable CPU time), the events for the rules that might need to be executed are evaluated. This pre-processing step thus provides an indication as to which of the various candidate rules will need to be assessed. For candidate rules whose events have not occurred, these are removed from the execution queue. However, for candidate rules whose events have occurred, these are then placed in another queue to determine efficient execution.

Another possible issue with the database functions for multi-tenant platforms is the restraint on how many database queries are allowed per unit time. Such limitations are imposed to ensure that the various tenants in the platform are allowed to access the shared resources. It should be clear that, to pre-process the various candidate rules to determine if each rule is to be executed (or implemented), the event or events that would trigger each rule has to be assessed. Assessment of such events may necessitate one or more database operations and, to ensure an efficient execution, these database operations may be stacked or combined. As an example, one event for one rule may require that the name on a specific record be retrieved while another event for another rule may require that the marital status indicated in the same record has to have a certain value (i.e. requiring a retrieval of the marital status value). Similarly, a third event may be to determine if the age listed on the record has changed within the last 6 months. Thus, if these various record checks are to be executed serially, this would require three serial and separate database operations. However, by “stacking” or combining the various database operations, a single retrieve operation. For this example, a single retrieve record operation that retrieves the name on the record, the marital status on the record, and the last date of the change in age in the record would accomplish, with a single operation, what would have taken multiple operations.

It should be clear that the above may be accomplished by determining the “context” of the various candidate rules (i.e. which records need to be retrieved/checked to assess the triggering events for each of the candidate rules) and then combining database operations that relate to the same records. Thus, if multiple events relating to record A have to be assessed, then the various fields in record A can be retrieved in a single operation.

Once the triggering events for the various candidate rules have been assessed (with the suitable combining of the various database, the candidate rules whose triggering events have been assessed to have occurred are then placed in another queue for further assessment. Once placed in the other queue for execution, to ensure efficient execution of database operations, the actions or conditions of each of the rules are assessed to determine the new “context” for the rules. Of course, this new context would be the records and/or fields that would need to be retrieved/changed/added/deleted from the database. Once the new context is determined, then the database operations are again stacked to ensure a more efficient execution of the operations. Much like in the explanation above, the database operations relating to the same records are combined (i.e. “stacked”) to ensure that the least amount of database operations are passed to the database.

The system may also include a formula engine that allows for complex, nested logic for both rule evaluation and rule result calculations that, in one implementation, allows no code to be written. This formula engine would be available at runtime since, for some implementations, a platform-based engine would only be available at the database layer.

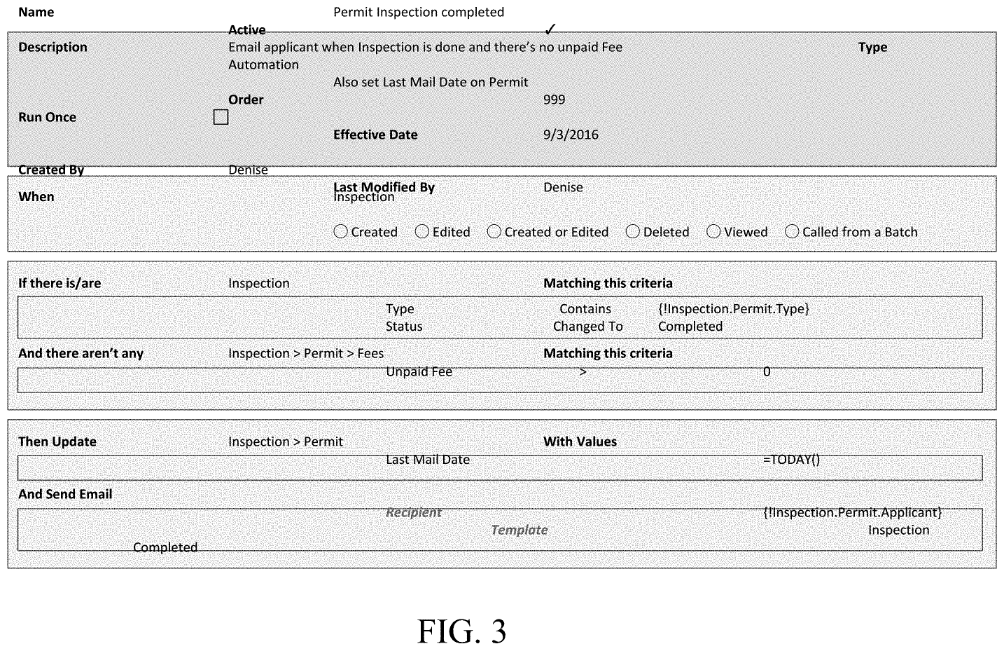

Regarding the definition of the rules, FIG. 3 shows a screenshot of a sample rule definition screen for use by users. As can be seen, a user can indicate the actions to be taken after the rule is executed, the order and frequency of the rule, as well as the triggering event (the “when” field), the condition for the rule (the “if there is/are” field), the negative condition for the rule (the “and there aren't any” field), and the consequence field (the “then update” field). The previously optional action is also indicated in FIG. 3 (the “And send email” field). As can be seen from FIG. 3, this rule definition relates to a permit inspection. The various bolded field names indicate the fields for completion by the user defining the rule while the unbolded text indicates entries in those fields. As an example, in the And there aren't any field, the entry “Unpaid fee” is the variable in the condition while the “>0” form the rest of the condition. Thus, the condition is that there must not be “unpaid fee” that is greater than (“>”) zero. The other condition is incomplete as the rule definition is unfinished.

As can be seen in FIG. 2, a user interface module 220 is present in one aspect of the present invention. This module is used to automatically generate user interfaces for use by consumers as the consumer navigates or accesses the various portals for the system. The user interface is automatically generated by taking in a field and data document pre-prepared by a user, determining the different components to be used in the user interface (along with determining how to present/handle such components), and then passing such data to a consumer's web browser to render the user interface. It should be clear that, although the following description references database-based processes (i.e. retrieving, saving, and editing records in a database), the concepts and methods explained below can also be used for non-database based processes. As well, while the context of the following description is that of a system or portal for providing government services to consumers, the automated user interface generation method and system can be used for other environments and contexts as well.

The process of this aspect of the invention begins with a consumer accessing a suitable web portal and requesting that a government service related task be performed. In some implementations, this can be requesting a permit, a license, or some other government regulated/issued credential/documentation.

The consumer's web browser then makes a call to the server backend to retrieve the appropriate application form for the consumer. The server backend then receives the request to generate an application type selection presentation to allow the consumer to select the type of application desired. The applications are those noted in FIG. 2 for one implementation.

To determine which applications are available to the consumer, the system makes calls to the API for the underlying cloud-computing platform. This causes the interrogation of the platform's database security model to determine which Record Types are available (given the permissions) to the consumer to create, view, and edit. The record types that are available for the consumer to create, view, and edit determines what applications may be launched for the consumer.

Once the Record Types available to the consumer are known, the applications which may be launched by the user are presented to the user in a suitable initial user interface. The consumer can then select which application is desired.

With the desired application selected, the system can then automatically generate a suitable user interface for the application. It should be clear that the above steps relating to the selection of a desired application may be skipped if the consumer's desired application is already known or if the system only provides a single application for use by the consumer.

The selection of an application triggers a call to the server/system back-end to retrieve the relevant application intake presentation/workflow. If the selection process has been executed, the back-end obtains user selection information via URL parameters and makes call to a service that will generate the visual tree of the application intake process for the user's selected application.

An Application Workflow Builder Service then makes calls to the platform's API to determine the consumer's field layout for the application. The field layout and the fields necessary for the application are predefined and are based on the platform's data schema.

It should be clear that responses to queries for this field and field data information may return data structures that may need to be parsed to suitably extract the necessary information.

To further retrieve data necessary for the user interface, the Application Workflow Builder Service makes further calls to the platform API to determine the consumer's related list information. This provides data as to what is related to the consumer's desired application and, as such, what may need to be rendered/retrieved for the user interface to be generated. As with the field and field data, queries may return data in a form necessitating a parsing of the data to extract the necessary information.

With the data required for the user interface, a representation of the visual tree of the user interface layout can then be generated. In one implementation, the Application Workflow Builder Service creates an object graph modelling using classes that represents the visual tree of the layout of the application intake workflow. This tree can then be traversed. Tree traversal ensures that the information necessary to render/present the various components to the consumer is present and that only the necessary information is used/accessed.

Traversing the tree may involve recognizing non-regular sections and the data associated with such sections. As well, traversing the tree may involve determining which sections require special handling procedures and which components may be used to handle the data in such sections and which data in which sections may be handled by usual or pre-existing measures. Of course, some sections may have predefined special names with predefined handling procedures, and these are registered into a registry along with their handling procedures. This ensures that the system can, when necessary, perform lookup operations in the registry to find the necessary handling procedures for the data in such sections when such sections are encountered in the tree traversal. For regular sections, the data can simply be handled using label/input control pairs.

In addition to the tree traversal, the system also traverses the related lists noted above. These lists may be special sections in the tree and, as such, may be entered in the registry. For the list traversal, the various entries in the related list are assessed to determine which entries are to be presented in the user interface, how to present the data in those entries, and which components are used to present the entry or the data in the entries. Preferably, the components to be used to render/present the entry and its data are listed in the registry noted above. Of course, if the related list is not entered in the registry, then the related list is not presented to the consumer on the user interface. If the related list is entered in the registry, then the component noted as to be used for the related list is used to present the list to the consumer.

It should be clear that, by the time the system has finished traversing the object graph of the tree, the system should have sufficient data (and instructions) regarding the logical structure of the presentation of the user interface. With this data, the system then returns data back to the consumer's browser with instructions on how to render the application intake process to the user. This provides the user interface necessary for the desired process.

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “APEX”, “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A method for managing changes to a database, the method comprising:
(a) receiving input from a consumer requiring at least one change to at least one record in a database;
(b) determining a plurality of candidate rules that would need to be implemented if triggering events for each of said candidate rules have occurred because of said at least one change;
(c) pre-processing said plurality of candidate rules to determine if all triggering events for each of said candidate rules have occurred;
(d) pre-processing all conditions for all candidate rules for which all triggering events have occurred to determine if said all conditions have been met;
(e) pre-processing consequences for all candidate rules for which all triggering events have occurred and for which all conditions have been met;
(f) implementing said consequences for said all candidate rules for which all triggering events have occurred and for which all conditions have been met;
wherein, for each rule,
said rule is only implemented when all of said rule's triggering events have occurred, an implementation of said rule includes determining if said one or more conditions are met and, if said one or more conditions are met, implementing said consequences for said rule.

2. The method according to claim 1, wherein step (c) comprises determining which data from which records need to be retrieved to determine if all triggering events for each of said candidate rules have occurred and stacking database queries to ensure a minimum number of database queries are executed to determine if all triggering events for each of said candidate rules have occurred.

3. The method according to claim 1, wherein step (d) comprises determining which data from which records need to be retrieved to determine if all conditions for all candidate rules for which all triggering events have occurred and stacking database queries to ensure a minimum number of database queries are executed to determine if all conditions for all candidate rules for which all triggering events have occurred.

4. The method according to claim 1, wherein step (f) comprises determining which records are affected by said consequences for all candidate rules for which all triggering events have occurred and for which all conditions have been met and organizing required database operations to implement said consequences such that when step (f) is executed, a minimum number of database operations are executed.

5. The method according to claim 1, further comprising executing at least one action for at least one candidate rule for which all triggering events have occurred and for which all conditions have been met.

6. The method according to claim 1, further comprising executing at least one non-database related action for at least one candidate rule for which all triggering events have occurred and for which all conditions have been met.

7. The method according to claim 1, wherein said records in said database relate to government records.

8. The method according to claim 1, wherein said records in said database relate to at least one of:
permits;
application for permits;
licenses;
applications for licenses;
inspections;
zoning applications;
reported complaints;
reported complaints relating to one or more bylaws;
reported complaints relating to ordinances;
general requests relating to one or more government agencies;
professional certifications;
examinations relating to one or more certifications;
courses relating to one or more certifications; and
regulation enforcement.

9. The method according to claim 1, wherein said database is part of a software platform providing cloud computing services, said platform being used to execute software applications that are used by consumers to access government services.

10. A method for managing changes to a database, the method comprising:
(a) receiving a request from a consumer for services, said services requiring at least one change to at least one record in said database;
(b) determining a plurality of candidate rules whose triggering events need to be evaluated to determine if said rules are to be executed for said services, each of said candidate rules being user defined and having one or more triggering events, one or more conditions, and one or more consequences;
(c) determining one or more records affected by an evaluation of said triggering events for each of said candidate rules and retrieving said one or more records;
(d) evaluating said triggering events using said one or more records retrieved in step (c);
(e) discarding candidate rules for whom at least one triggering event has not occurred to result in remaining candidate rules;
(f) for each of said remaining candidate rules, determining one or more records affected by an evaluation of conditions for each of said remaining candidate rules;
(g) retrieving said one or more records determined in step (f) and evaluating said conditions for said each of said remaining candidate rules;
(h) for each of said remaining candidate rules for which conditions have been met, determining which change records would be affected by an implementation of consequences for each of said remaining candidate rules for which conditions have been met;
(i) committing changes to said change records determined in step (h) in accordance with said consequences for each of said remaining candidate rules for which conditions have been met;
wherein, for each rule,
said rule is only implemented when all of said rule's triggering events have occurred, an implementation of said rule includes determining if said one or more conditions are met and, if said one or more conditions are met, implementing said consequences for said rule.

11. The method according to claim 10, wherein step (c) comprises consolidating said one or more records to thereby minimize a number of database queries to retrieve said one or more records.

12. The method according to claim 10, wherein step (e) comprises consolidating said one or more records to thereby minimize a number of database queries to retrieve said one or more records.

13. The method according to claim 10, wherein step (g) comprises pooling said changes to said change records to thereby minimize a number of writes to said database when committing said changes.

14. The method according to claim 10, wherein step (h) comprises implementing one or more other actions defined for each of said remaining candidate rules for which conditions have been met.

15. A method for dynamically generating a user interface containing user fillable fields, said user interface being related to a specific process, the method comprising:
(a) retrieving data detailing required data fields for said user interface and field indicators for said required data fields;
(b) retrieving data detailing resources related to said process;
(c) retrieving data detailing components to be used for said user interface and procedures for handling said object types;
(d) generating a visual tree representation detailing components to be used for said user interface;
(e) traversing said visual tree representation to determine how each component is to be generated or presented to a consumer;
(f) rendering said user interface based on results of step (e).

16. The method according to claim 15, wherein said specific process is related to records in a database.

17. The method according to claim 15, further comprising a step of determining, prior to step (a), which specific process said user interface is for.

18. The method according to claim 17, wherein said step of determining which specific process said user interface is for includes receiving consumer input and determining which specific processes are available for said consumer to access.

19. The method according to claim 17, wherein said step of determining which specific process said user interface is for comprises accessing at least one security model of an underlying software platform that provides cloud computing services to provide said specific process, said at least one security model indicating which records in a database are accessible to said consumer.

20. The method according to claim 19, wherein said data detailing required data fields for said user interface and field indicators for said required data fields is based on predetermined requirements fro said underlying software platform.

21. The method according to claim 15, wherein step (f) is executed by passing instructions for handling of said components to a consumer's web browser.

22. A system for managing consumer-initiated requests relating to government services, the system comprising
a dynamic rules engine embodied in computer readable and computer executable instructions, said dynamic rules engine being for implementing and assessing a plurality of rules relating to said requests, said requests relating to records in at least one database;
a dynamic user interface engine embodied in computer readable and computer executable instructions, said dynamic user interface engine being for generating a user interface for use by said consumer to initiate said requests;
wherein said dynamic rules engine receives consumer input by way of said user interface generated by said dynamic user interface engine.

23. The system according to claim 22, wherein said computer readable and computer executable instructions that embody said dynamic rules engine, when executed by at least one processor, implements a method for managing changes to a database, the method comprising:
(a) receiving input from a consumer requiring at least one change to at least one record in a database;
(b) determining a plurality of candidate rules that would need to be implemented if triggering events for each of said candidate rules have occurred because of said at least one change;
(c) pre-processing said plurality of candidate rules to determine if all triggering events for each of said candidate rules have occurred;
(d) pre-processing all conditions for all candidate rules for which all triggering events have occurred to determine if said all conditions have been met;
(e) pre-processing consequences for all candidate rules for which all triggering events have occurred and for which all conditions have been met;
(f) implementing said consequences for said all candidate rules for which all triggering events have occurred and for which all conditions have been met;
wherein, for each rule,
said rule is only implemented when all of said rule's triggering events have occurred, an implementation of said rule includes determining if said one or more conditions are met and, if said one or more conditions are met, implementing said consequences for said rule.

24. The system according to claim 23, wherein said system interacts with a software platform that provides cloud computing services, said platform being used to execute said computer readable instructions that embody said dynamic rules engine.

25. The system according to claim 23, wherein said computer readable and computer executable instructions that embody said dynamic user interface engine, when executed by at least one processor, implements a method for dynamically generating a user interface containing user fillable fields, said user interface being related to a specific database related process, the method comprising:
(a) retrieving data detailing required data fields for said user interface and field indicators for said required data fields;
(b) retrieving data detailing resources related to said process;
(c) retrieving data detailing component types to be used for said user interface and procedures for handling said object types;
(d) generating a visual tree representation detailing components to be used for said user interface;
(e) traversing said visual tree representation to determine how each component is to be generated or presented to a user;
(f) rendering said user interface based on results of step (e).
